(19) United States
(12) Patent Application Publication
(10) Pub. No.: US 2025/0190172 A1
(43) Pub. Date: Jun. 12, 2025

(54) DETERMINING PHYSICAL ADDRESSES OF MEMORY DEVICES USING DIVISION BY PRIME NUMBERS

(71) Applicant: Microchip Technology Incorporated, Chandler, AZ (US)

(72) Inventors: James LEIGHTON, Orangevale, CA (US); Hichem BELHADJ MOHAMED, Loomis, CA (US)

(21) Appl. No.: 18/935,414

(22) Filed: Nov. 1, 2024

Related U.S. Application Data
(60) Provisional application No. 63/609,341, filed on Dec. 12, 2023.

(51) Int. Cl. G06F 7/501; G06F 7/535

(52) U.S. Cl. CPC G06F 7/501; G06F 7/535

(57) ABSTRACT

A processing unit, associated with a host device, adapted to receive a request to calculate a first physical address of an external device based on a second physical address of the host device; determine a tree of parallel adders corresponding to the division operation; obtain an output value from the tree of parallel adders based on the input values; and calculate the first physical address using the output value. The first physical address of the external device is to be calculated based on a division operation that divides the second physical address by a divisor. The tree of parallel adders is determined based on input values that include a number of bits of the second physical address and a divisor.

### RELATED APPLICATION

This application claims priority to U.S. Provisional Patent Application No. 63/609,341 entitled “DETERMINING PHYSICAL ADDRESSES OF MEMORY DEVICES USING DIVISION BY PRIME NUMBERS,” filed Dec. 12, 2023, which is incorporated herein by reference in its entirety.

### FIELD

The present disclosure generally relates to performing long divisions using prime numbers under time constraints and, for example, to determining physical addresses under time constraints based on performing long divisions.

### BACKGROUND

A dynamic random-access memory (DRAM) may store data. A DRAM may be used as part of implementing memory interleaving. Physical address for memory interleaving may be calculated by performing divisions using prime intervals. Generally, performing divisions using prime numbers is a time-consuming and logic resources intensive process.

### SUMMARY

In some implementations, a method comprising: receiving a request to calculate a first physical address of an external device based on a second physical address of the host device, wherein the first physical address of the external device is to be calculated based on a division operation that divides the second physical address by a divisor that is a prime number or a multiple of a prime number; determining a tree of parallel adders corresponding to the division operation, wherein the tree of parallel adders is determined based on input values that include a number of bits of the second physical address and the divisor; obtaining an output value from the tree of parallel adders based on the input values; and calculating the first physical address using the output value.

In some implementations, a system comprising: a processing unit, associated with a host device, adapted to: receive a request to calculate a first physical address of an external device based on a second physical address of the host device, wherein the first physical address of the external device is to be calculated based on a division operation that divides the second physical address by a divisor; obtain an output value from the tree of parallel adders based on the input values; and calculate the first physical address using the output value.

In some implementations, a computer program product comprising: one or more computer readable storage media, and program instructions collectively stored on the one or more computer readable storage media, the program instructions comprising: program instructions to receive a request to calculate a first physical address of an external device based on a second physical address of the host device, wherein the first physical address of the external device is to be calculated based on a division operation that divides the second physical address by a divisor; program instructions to determine a tree of parallel adders corresponding to the division operation, wherein the tree of parallel adders is determined based on input values that include a number of bits of the second physical address and a divisor; program instructions to obtain an output value from the tree of parallel adders based on the input values; and program instructions to calculate the first physical address using the output value.

### BRIEF DESCRIPTION OF THE DRAWINGS

FIG. 1 is a block diagram illustrating an example memory system configured to perform a hardware-based integer divide-by-prime operation, in accordance with the present disclosure.

FIG. 2 is a block diagram illustrating an example of a device, in accordance with the present disclosure.

FIG. 3A is a block schematic diagram illustrating an example of a divider, in accordance with the present disclosure.

FIG. 3B-3D are diagrams illustrating input shifter operations associated with a hardware-based integer divide-by-prime operation performed by the divider of FIG. 3A, in accordance with the present disclosure.

FIG. 3E-3G are diagrams illustrating bitfields associated with a hardware-based integer divide-by-prime operation performed by the divider of FIG. 3A, in accordance with the present disclosure.

FIGS. 4A-4C are diagrams illustrating examples of dividers for performing hardware-based integer divide-by-prime operations.

FIG. 5 is a flowchart of an example process 500 associated with determining physical addresses of memory devices using division by prime numbers.

### DETAILED DESCRIPTION

The following detailed description of example implementations refers to the accompanying drawings. The same reference numbers in different drawings may identify the same or similar elements.

In modern computing systems, integer division is a fundamental arithmetic operation that is widely employed in various hardware-based processes. One such application is in the context of Compute Express Link (CXL) technology, where hardware-based integer division is utilized for interleaving purposes. CXL is based on the Peripheral Component Interconnect Express (PCIe) Gen5, Gen6, or later generation link infrastructure to provide an open interconnect standard for enabling efficient, coherent memory access between a host, such as a CPU, and a device, such as a hardware accelerator or a memory expansion device that is handling an intensive workload.

CXL has been developed as a standard to provide an improved, high-speed CPU-to-device and CPU-to-memory interconnect that will accelerate next-generation data center performance and emerging computing applications, such as artificial intelligence, machine learning, and other applications. CXL maintains memory coherency between the CPU memory space and the memory space of attached devices, which provides for resource sharing, thereby enabling high performance, reduced complexity and lower overall system costs.

CXL supports a set of protocols that include input/output (I/O) semantics (CXL.io), which are similar to PCIe I/O semantics, caching protocol semantics (CXL.cache), and memory access semantics (CXL.mem). The CXL.io protocol is equivalent to PCIe transport over the CXL protocol and CXL.mem is a memory access protocol that supports device-attached memory to provide a transactional interface between the CPU and the memory device. In some applications, the CXL protocols may be built upon the well-established and widely adopted PCIe infrastructure (e.g., PCIe Gen5, Gen6, or newer generations), thereby leveraging the PCIe physical interface and enhancing the protocol with CXL to provide memory coherency between a CPU memory and an accelerator device memory.

In CXL, interleaving is used to map Host Physical Addresses (HPAs) to Device Physical Addresses (DPAs), which allows for the efficient distribution of memory accesses across multiple devices. This mapping process involves dividing the HPAs by a certain divisor to determine the corresponding DPA, ensuring that memory accesses are balanced and optimized across the memory devices connected through the CXL interface.

The process of interleaving in CXL facilitates enhancing memory bandwidth and reducing latency, as it allows the system to distribute memory accesses across multiple memory devices. This distribution is often achieved through a hardware-based division operation, where the HPA is divided by a specified interleave size or a divisor that dictates the granularity of the interleaving. The result of this division is used to determine the specific DPA to which the memory access should be directed. By leveraging integer division in this manner, CXL technology can effectively manage and optimize memory access patterns, leading to improved overall system performance.

In hardware implementations, integer division can be performed using various techniques, including iterative algorithms or more sophisticated hardware-based approaches. The iterative nature of traditional integer division algorithms, such as the restoring division algorithm or non-restoring division algorithm, involves a sequence of subtraction and shifting operations that are repeated over multiple cycles. While these methods are reliable, they can be relatively slow and resource-intensive, particularly when dealing with large divisors or high-precision requirements. Consequently, in time-critical applications such as CXL interleaving, the latency introduced by multi-cycle division operations can become a performance bottleneck.

Integer division operations, especially when implemented iteratively, are inherently resource-intensive due to the need for multiple cycles to complete the computation. Each cycle in a traditional division algorithm typically involves a comparison, subtraction, and shift operation, which collectively consume significant computational resources. When dealing with high-frequency operations, the cumulative delay caused by division spanning across multiple cycles can adversely impact system performance. For instance, in the context of CXL interleaving, the delay introduced by multi-cycle integer division can limit the effectiveness of interleaving, leading to suboptimal memory access patterns and degraded system efficiency. As a result, there is a need for more efficient hardware-based integer division techniques that can perform the operation in a single cycle, thereby reducing latency and improving the overall performance of systems employing CXL technology.

Implementations described herein provide a hardware-based integer divide-by-prime operation that can be performed in a single clock cycle. This operation may be implemented using a tree of parallel adders, which may be designed to perform the division operation in a pipelined manner. The adder tree may be configured based on the input value, the divisor, and/or a pre-calculated offset. The offset may be determined based on the number of bits in the input value and the divisor. The tree may be designed to have a depth of O(log 2(n/2)), where n is the number of bits in the input value.

Aspects of the disclosure may be implemented using a hardware circuit that includes a tree of parallel adders, a shifter, and a truncation unit. The tree of parallel adders may be configured to perform the division operation in a pipelined manner. The shifter may be used to shift the input value by a number of bits that is based on the divisor. The truncation unit may be used to truncate the output value based on the offset. Some implementations may include pre-calculating certain values, such as the initial vector and rounding factor, and using these values as inputs to the adder tree. A rounding factor may be used to ensure that the output value is accurate. The output value may be truncated based on the offset to produce the final interleave address. The adder tree may be designed to perform a series of parallel additions, with each stage reducing the number of bits in the input value by half. The final output of the adder tree may be truncated to the desired number of bits, resulting in the quotient of the division operation.

Some implementations leverage a pipeline-able tree of parallel adders to recast iterative division into a parallel operation. This approach may reduce the computational complexity and latency, enabling single-cycle division for prime divisors. Some implementations provide a method for calculating CXL interleave addresses by dividing an HPA by a prime divisor, resulting in a DPA. The method may include determining a tree of parallel adders based on the input values, including the number of bits in the HPA and the prime divisor. The output value from the tree may be used to calculate the DPA.

Some implementations may enable the support of CXL 3/6/12-way interleave modes, which are commonly used in modern memory systems. Some implementations may enable the implementation of cryptographic algorithms that require fast division by complex primes. Some implementations may be beneficial for applications that require high-performance address translation, such as memory systems and network interfaces. Accordingly, some implementations described herein may provide a number of advantages over conventional methods of calculating interleave addresses. For example, some implementations may be faster than conventional methods, as they can be performed in a single clock cycle. Additionally, some implementations may be more efficient than conventional methods, as they may require less hardware resources. Further, some implementations may be more flexible than conventional methods, as they can be used to support various interleave modes and prime divisors.

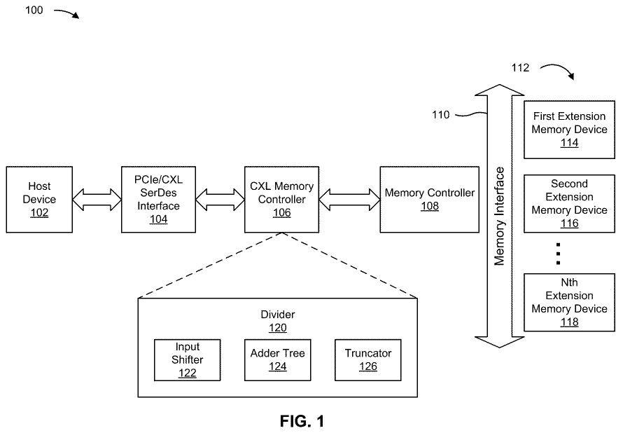

FIG. 1 is a block diagram illustrating an example memory system 100 configured to perform a hardware-based integer divide-by-prime operation, in accordance with the present disclosure. The memory system 100 includes a host device 102, a PCIe/CXL serializer/deserializer (SerDes) interface 104, a CXL memory controller 106, a memory controller 108, a memory interface 116, and a set 112 of extension memory devices. The set 112 of extension memory devices includes, for example, a first extension memory device 114, a second extension memory device 116, and an Nth extension memory device 118.

The CXL memory controller 106 may receive data packets over the PCIe/CXL SerDes interface 104 from the host device 102. The host device may include, for example, a CPU. Data transfer operations between the host device 102 and an extension memory device 114, 116, and/or 118 are initiated over the PCIe/CXL SerDes interface 104. The CXL memory controller 106 plays a role in managing and facilitating the efficient transfer of data. When the host device 102 issues a request to read from or write to the extension memory device 114, 116, and/or 118, the data is first transmitted over the high-speed PCIe/CXL SerDes interface 104. The PCIe/CXL SerDes interface 104 converts the parallel data from the host device 102 into a serial data stream for transmission, ensuring high bandwidth and low-latency communication between the host device 102 and the CXL memory controller 106.

Upon receiving the data or memory access request via the PCIe/CXL SerDes interface 104, the CXL memory controller 106 decodes the incoming information to determine the type of operation-either a read or write request. For write operations, the CXL memory controller 106 prepares to receive data from the host device 102 that will be stored in the extension memory device 114, 116, and/or 118. Conversely, for read operations, the CXL memory controller 106 will retrieve data from the extension memory device 114, 116, and/or 118 to be sent back to the host device 102. To effectively manage memory accesses, the CXL memory controller 106 maps the HPAs provided by the host device 102 to the corresponding DPAs within the extension memory device 114, 116, and/or 118.

CXL interleaving is a mechanism employed by the CXL memory controller 106 to optimize this mapping process. Interleaving allows the CXL memory controller 106 to distribute memory accesses evenly across multiple extension memory devices 114, 116, and 118. This distribution is achieved by dividing the HPAs into segments and mapping each segment to a different memory device or memory channel within the extension memory device 114, 116, and/or 118. The interleaving process ensures that the memory bandwidth is maximized, and latency is minimized by balancing the load across multiple devices. An integer division operation, performed by the CXL memory controller 106, is integral to this process, as it computes the DPA by dividing the HPA by a divisor that defines the interleave size. This divisor is typically based on the number of memory devices or channels available for interleaving.

Once the appropriate DPA is determined through the interleaving process, the CXL memory controller 106 communicates with the memory controller 108 associated with the extension memory device 114, 116, and/or 118. This communication involves sending the DPA, along with any associated command and data (for write operations), to the memory controller 108, which then takes charge of executing the memory access operation. The memory controller 108, in turn, interacts with the physical layer of the extension memory device 114, 116, and/or 118, which is responsible for the actual read or write operation at the physical memory cells. The physical layer ensures that data is correctly read from or written to the specific memory locations as dictated by the DPA.

For read operations, after retrieving the data from the extension memory device 114, 116, and/or 118, the memory controller 108 sends the data back to the CXL memory controller 106. The CXL memory controller 106 then re-encodes the data into a serial format suitable for transmission back to the host device 102 over the PCIe/CXL SerDes interface 104. For write operations, the CXL memory controller 106 ensures that the data received from the host device 102 is correctly written to the specified locations in the extension memory device 114, 116, and/or 118 via the memory controller 108. Thus, the CXL memory controller 106 serves as an intermediary that manages the process of data transfer between the host device 102 and the extension memory device 114, 116, and/or 118.

To facilitate efficient dividing operations, the CXL memory controller 106 may include a divider 120 configured to perform hardware-based integer divide-by-prime operations. The divider 120 may be, include, or be included in a hardware circuit. In some implementations, the divider 120 may include a processor, memory, and/or a software component. In some implementations, the divider 120 may be configured to perform an integer divide-by-prime operation in a single clock cycle.

As shown, the divider 120 includes an input shifter 122, an adder tree 124, and a truncator 126. The input shifter 122 may be used to shift an input value by a number of bits that is based on the divisor. The adder tree 124 is a tree of parallel adders that may be configured to perform the division operation in a pipelined manner. The adder tree 124 may be designed to have a depth of O(log 2(n/2)), where n is the number of bits in the input value. The truncator 126 may be used to truncate the output value based on the offset. Some implementations may include pre-calculating certain values, such as an initial vector and rounding factor, and using these values as inputs to the adder tree 124. A rounding factor may be used to ensure that the output value is accurate. The output value may be truncated based on the offset to produce the final interleave address. The adder tree 124 may be designed to perform a series of parallel additions, with each stage reducing the number of bits in the input value by half. The final output of the adder tree 124 may be truncated to the desired number of bits, resulting in the quotient of the division operation.

As indicated above, FIG. 1 is provided as an example. Other examples may differ from what is described with regard to FIG. 1. The number and arrangement of components of the memory system 100 shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more functions described as being performed by another set of components shown in FIG. 1.

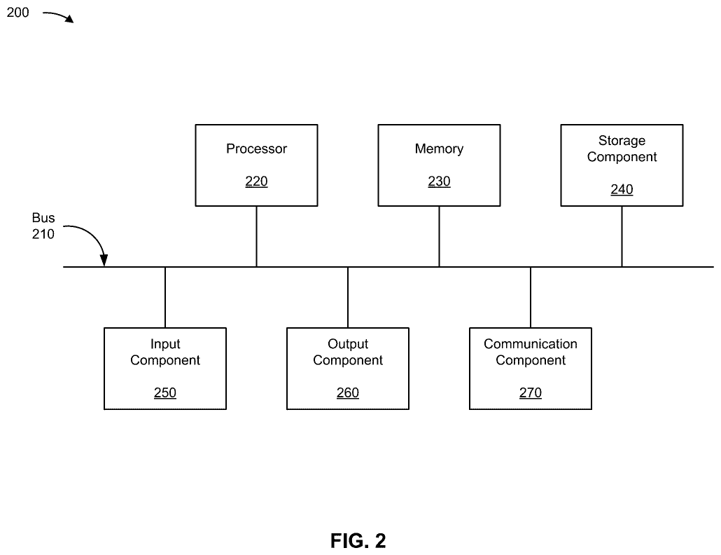

FIG. 2 is a diagram of example components of a device 200, which may correspond to one or more components of FIG. 1. In some implementations, the memory system 100 and/or one or more components of the memory system 100 may include one or more devices 200 and/or one or more components of device 200. In some implementations, one or more devices 200 and/or one or more components of device 200 may include the memory system 100 and/or one or more components of the memory system 100. As shown in FIG. 2, device 200 may include a bus 210, a processor 220, a memory 230, a storage component 240, an input component 250, an output component 260, and a communication component 270.

Bus 210 includes a component that enables wired or wireless communication among the components of device 200. Processor 220 may be a central processing unit, a graphics processing unit, a microprocessor, a controller, a microcontroller, a digital signal processor, a field-programmable gate array, an application-specific integrated circuit, or another type of processing component. Processor 220 is implemented in hardware, firmware, or a combination of hardware and software. In some implementations, processor 220 includes one or more processors capable of being programmed to perform a function. Memory 230 includes a random access memory, a read only memory, or another type of memory (e.g., a flash memory, a magnetic memory, or an optical memory).

Storage component 240 stores information or software related to the operation of device 200. For example, storage component 240 may include a hard disk drive, a magnetic disk drive, an optical disk drive, a solid state disk drive, a compact disc, a digital versatile disc, or another type of non-transitory computer-readable medium. Input component 250 enables device 200 to receive input, such as user input or sensed inputs. For example, input component 250 may include a touch screen, a keyboard, a keypad, a mouse, a button, a microphone, a switch, a sensor, a global positioning system component, an accelerometer, a gyroscope, or an actuator. Output component 260 enables device 200 to provide output, such as via a display, a speaker, or one or more light-emitting diodes. Communication component 270 enables device 200 to communicate with other devices, such as via a wired connection or a wireless connection. For example, communication component 270 may include a receiver, a transmitter, a transceiver, a modem, a network interface card, or an antenna.

Device 200 may perform one or more processes described herein. For example, a non-transitory computer-readable medium (e.g., memory 230 or storage component 240) may store a set of instructions (e.g., one or more instructions, code, software code, or program code) for execution by processor 220. Processor 220 may execute the set of instructions to perform one or more processes described herein. In some implementations, execution of the set of instructions, by one or more processors 220, causes the one or more processors 220 or the device 200 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 2 are provided as an example. Device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

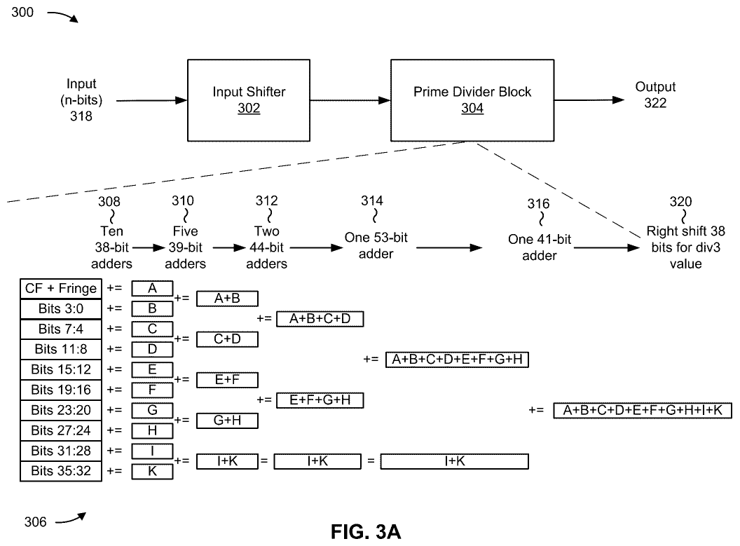

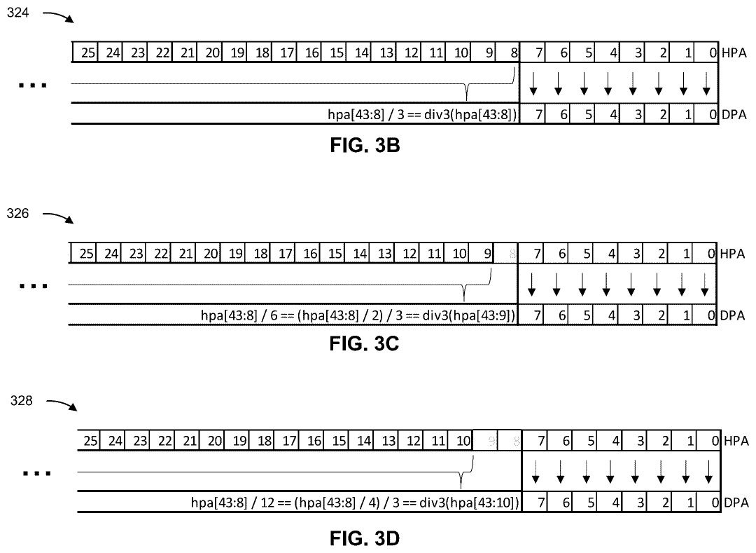

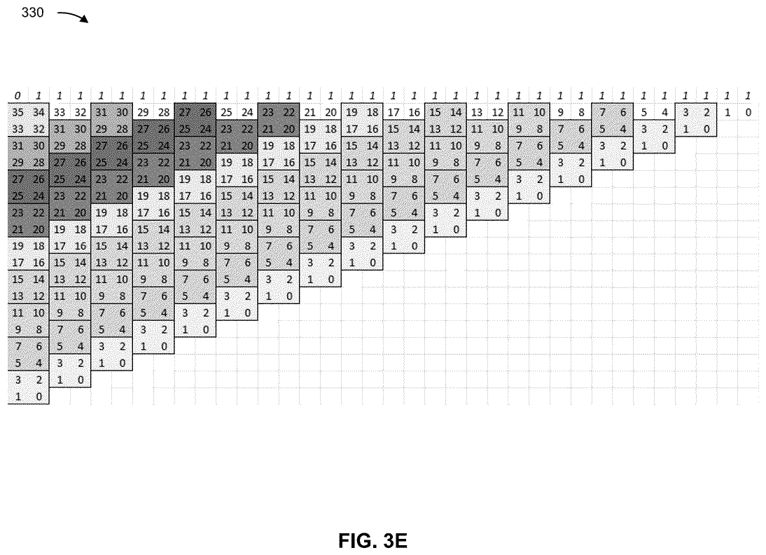

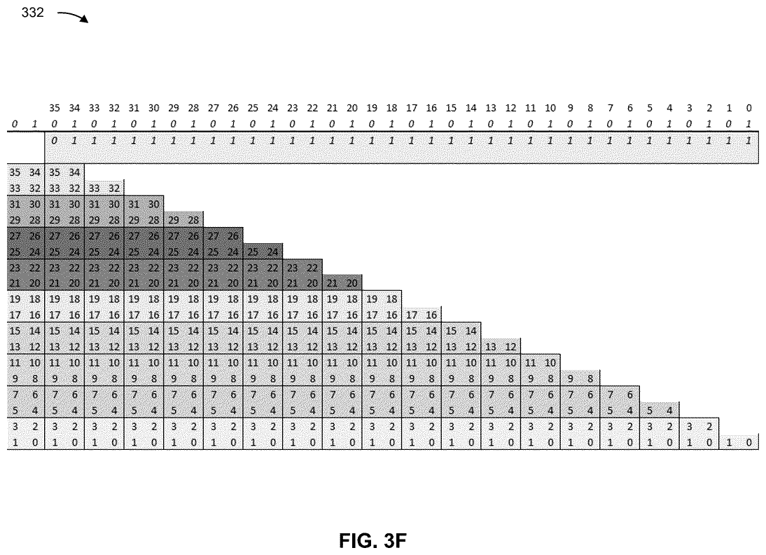

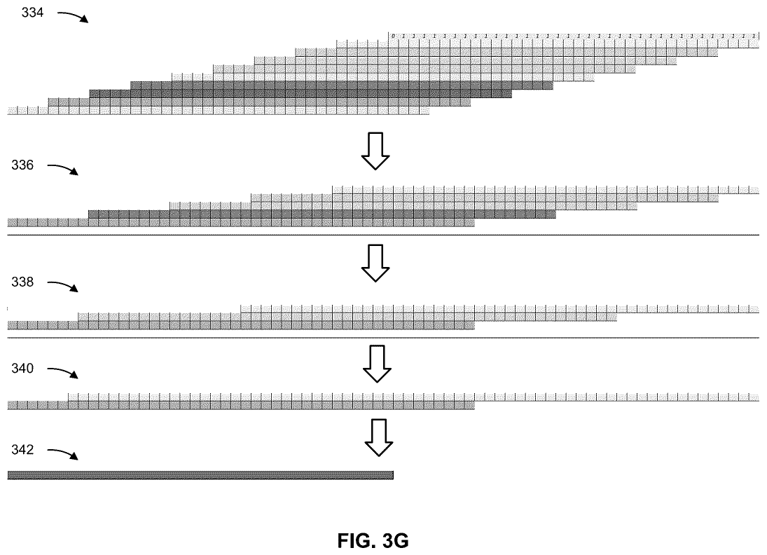

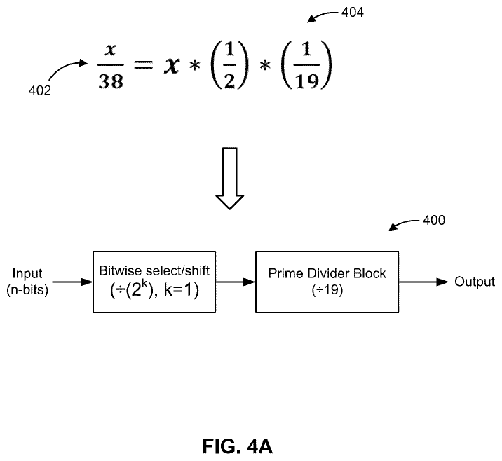

FIG. 3A is a block schematic diagram illustrating an example of a divider 300, in accordance with the present disclosure. The divider 300 may be, be similar to, include, or be included in, the divider 120 shown in FIG. 1. As shown, the divider 300 may include an input shifter 302 and a prime divider block 304. The prime divider block 304 may include an adder tree 306 that includes a number of parallel adders 308, 310, 312, 314, and 316.

The divider 300 may be configured to perform hardware-based integer divide-by-prime operations, which may be used for calculating physical addresses in memory systems. In this context, a physical address may refer to a specific location in a memory device where data is stored or retrieved. The divider 300 may be used to calculate a first physical address of an external device based on a second physical address of the host device. In some implementations, the divider 300 may be configured to perform division operations by one or multiple prime numbers. For example, the divider 300 may be configured to perform division operations by 3, 6, and 12, which may be used to support these interleave modes. The divider 300 may be used in cryptographic algorithms that require fast division by complex primes. These algorithms may be used to encrypt and decrypt data. The divider 300 may be configured to perform division operations by complex primes, which may be used to accelerate these algorithms.

The input shifter 302 of the divider 300 may be configured to receive a request to calculate the first physical address. The request may include the second physical address as an input value. The input shifter 302 may perform a shift operation on the input value, shifting it by a number of bits that is based on the divisor. The divisor, in some cases, may include a prime number or a multiple of a prime number. The shift operation may be performed to optimize the subsequent division operation. For example, the input shifter 302 may be used to adjust the input value so that it can be properly divided by the divisor. The input shifter 302 may be designed to shift the input value by a power of two, which is determined by the divisor. For example, if the divisor is 6, which is a multiple of the prime number 3, the input shifter 302 may shift the input value by one bit to the right. This shift operation effectively divides the input value by two, which is a factor of the divisor.

The input shifter 302 may be implemented using a variety of different hardware circuits. For example, the input shifter 302 may be implemented using a combination of multiplexers, demultiplexers, shift registers, and/or other logic gates, among other examples. In some implementations, the divider 300 may include a multiplier instead of an input shifter 302. The multiplier may be configured to multiply the input value by a factor that is based on the divisor. For example, if the divisor is 3, then the multiplier may multiply the input value by 3, thereby ensuring that the input value is divisible by 3. In some implementations, the divider 300 may include a combination of an input shifter 302 and a multiplier. The input shifter 302 may be used to shift the input value by a number of bits that is based on the divisor. The multiplier may be used to multiply the shifted input value by a factor that is based on the divisor, thereby ensuring that the input value is divisible by the divisor.

The prime divider block 304 may be configured to perform a hardware-based integer divide-by-prime operation. The prime divider block 304 may include an adder tree 306 that includes a number of parallel adders 308, 310, 312, 314, and 316. The adder tree 306 may be configured to perform a series of parallel additions, with each stage reducing the number of bits in the input value by half. The final output of the adder tree 306 may be truncated to the desired number of bits, resulting in the quotient of the division operation. The adder tree 306 may be implemented using a variety of different hardware circuits. For example, the adder tree 306 may be implemented using a combination of full adders, half adders, and/or other logic gates.

In some implementations, the adder tree 306 may be designed to have a depth of O(log 2(n/2)), where n is the number of bits in the input value. The depth of the adder tree 306 may be determined by the number of bits in the input value and the divisor. For example, if the input value is 36 bits and the divisor is 3, then the depth of the adder tree 306 will be log 2(36/2)=4.25.

The adder tree 306 may be configured to perform the division operation in a pipelined manner. The adder tree 306 may be designed to have multiple stages, with each stage performing a parallel addition operation. The output of each stage is then fed into the next stage of the adder tree 306. This pipelined architecture may allow the adder tree 306 to perform the division operation in a single clock cycle. The adder tree 306 may be configured to perform the division operation by leveraging a pre-calculated offset. The offset may be determined based on the number of bits in the input value and the divisor. The offset may be used to truncate the output value from the adder tree 306 to obtain the final quotient. The offset may be determined by adding the number of bits in the input value to the logarithm (base 2) of the divisor. For example, if the input value is 36 bits and the divisor is 3, the offset may be 38 bits (36+log 2(3)).

The divider 300 may be configured to perform a division operation by leveraging a pre-calculated initial vector. The initial vector may be determined by dividing the entire domain size by the divisor. The initial vector may be used as an input to the adder tree 306. The initial vector may be determined by dividing 2\hat{ }n by the divisor, where n is the number of bits in the input value. For example, if the input value is 36 bits and the divisor is 3, the initial vector may be 2\hat{ }38/3. The divider 300 may be configured to perform the division operation by leveraging a pre-calculated rounding factor. The rounding factor may be determined based on the number of bits in the input value. The rounding factor may be used to ensure that the output value from the adder tree 306 is accurate. The rounding factor may be determined by subtracting 1 from 2\hat{ }n, where n is the number of bits in the input value. For example, if the input value is 36 bits, the rounding factor may be 2\hat{ }36−1. The divider 300 may be configured to perform the division operation by leveraging a pre-calculated constant. The constant may be determined based on the offset and the divisor. The constant may be used to obtain the output value from the adder tree 306. The constant may be determined by dividing 2\hat{ }n by the divisor, where n is the offset. For example, if the offset is 38 bits and the divisor is 3, the constant may be 2\hat{ }38/3.

In some implementations, the adder tree 306 may be designed to have a variable depth, which may be adjusted based on the divisor and/or the number of bits in the input value. This approach may provide greater flexibility and efficiency for handling different divisors and input values. In some implementations, the adder tree 306 may be configured to include look-ahead carry logic, which may be used to speed up the addition operations. Look-ahead carry logic may be used to predict the carry-out bits from each adder in the adder tree 306, which may allow for faster addition operations. In some implementations, the adder tree 306 may be configured to use carry-save adders, which may be used to reduce the number of carry propagation stages. Carry-save adders may be used to perform addition operations without generating carry-out bits, which may reduce the latency of the addition operations. In some implementations, the adder tree 306 may be configured to use parallel prefix adders, which may be used to perform addition operations in a logarithmic time complexity. Parallel prefix adders may be used to compute the sum and carry bits for each adder in the adder tree 306 in parallel, which may reduce the latency of the addition operations.

In operation, input 318 is provided to the input shifter 302, which may shift the input as described above. The shifted input may be provided to the prime divider block 304, which may calculate a preliminary output using the adder tree 306. The preliminary output may be processed further. In some implementations, the divider 300 may include a post-processing unit after the adder tree 306. This unit could perform operations such as truncation or rounding on the output value from the adder tree 306. The truncation operation may be based on an offset, which could be determined by the number of bits in the second physical address and the logarithm of the divisor at base two. For example, the preliminary output of the adder tree 306 may be processed using a right shift operation 320. The right shift operation 320 may be performed by a truncator configured to truncate the preliminary output based on an offset. The offset may include a particular number of bits. The truncator may be implemented using a logic gate or other suitable circuitry.

In some implementations, the divider 300 may include a feedback mechanism. The feedback mechanism may be configured to use the results of previous division operations to optimize future operations. For example, the divider 300 may adjust the initial shift amount or the rounding factor based on the accuracy of recent results, potentially improving the overall performance and accuracy of the divider 300 over time. In some implementations, the divider 300 may be designed to support multiple division algorithms. While the primary method may be the parallel adder tree approach, the divider could also include circuitry for other division methods, such as non-restoring division or SRT division. In this way, the divider 300 may be configured to adapt to different types of divisors or precision requirements as needed.

FIGS. 3B-3D illustrate input shifter operations 324, 326, and 328, respectively, associated with a hardware-based integer divide-by-prime operation performed by the divider 300 of FIG. 3A. The operations 324, 326, and 328 may be performed by the input shifter 302 as part of the process of calculating a first physical address of an external device based on a second physical address of a host device. The input shifter operations may be designed to optimize the subsequent division operation by adjusting the input value based on the divisor.

In FIG. 3B, the input shifter operation 324 may be performed when the divisor is 3, a prime number. As used herein, the term “prime number” may refer to a natural number greater than 1 that is only divisible by 1 and itself without leaving a remainder. For example, when the divisor is 3, the input shifter 302 may perform no shift operation on the input value, as the prime division block is configured to facilitate dividing by 3 already.

FIG. 3C depicts the input shifter operation 326, which may be employed when the divisor is a multiple of a prime number, such as 6 (which is 2 times 3). In this case, the input shifter 302 may perform a right shift operation on the input value by one bit (or, in other words, the constant in 304 is shifted left to multiply the prime by two)). This shift operation effectively divides the input value by 2, which may optimize the division operation for the divisor 6. The term “multiple of a prime number” as used herein may refer to a number that is the product of a prime number and an integer.

FIG. 3D illustrates the input shifter operation 328, which may be utilized when the divisor is a larger prime number or a multiple of larger prime numbers, such as 12 (which is 2 times 2 times 3). In this case, the input shifter 302 may perform a left shift operation on the input value by two bits. This shift operation effectively multiplies the input value by 4, which may optimize the division operation for the divisor 12.

The input shifter operations 324, 326, and 328 may be designed to support various interleave modes in memory systems. As used herein, the term “interleave mode” may refer to a technique for distributing memory accesses across multiple memory devices or channels to improve overall system performance. For instance, the input shifter operations may be optimized to support 3-way, 6-way, and 12-way interleave modes, which correspond to divisors of 3, 6, and 12, respectively.

FIG. 3E-3G are diagrams illustrating bitfields associated with a hardware-based integer divide-by-prime operation performed by the divider 300 of FIG. 3A, in accordance with the present disclosure.

FIG. 3E illustrates a bitfield 330 associated with the hardware-based integer divide-by-prime operation performed by the divider 300. The bitfield 330 may represent the input value and the constant pattern used in the division operation. As used herein, the term “bitfield” may refer to a data structure that consists of one or more adjacent bits representing a specific value or flag. In some implementations, the bitfield 330 may include a series of bits representing the input value, which may be a second physical address of a host device. The constant pattern in the bitfield 330 may be determined based on the divisor used in the division operation.

The bitfield 330 may be designed to optimize the division operation by arranging the bits in a specific pattern that facilitates parallel processing. For example, the bitfield 330 may include repeating patterns of bits that correspond to the divisor. In the case of dividing by 3, the pattern may repeat every two bits, while for dividing by 5, the pattern may repeat every four bits. This arrangement allows the adder tree 306 to process multiple bits simultaneously, potentially reducing the overall latency of the division operation.

FIG. 3F depicts a bitfield 332 that may represent an intermediate stage in the division operation. The bitfield 332 may include partial results from the adder tree 306. As used herein, the term “partial results” may refer to intermediate values generated during the computation process that contribute to the final quotient. The bitfield 332 may be organized in a way that facilitates the reduction of bits in each stage of the adder tree 306.

In some implementations, the bitfield 332 may include multiple rows, with each row representing a stage in the adder tree 306. The number of bits in each row may decrease as the computation progresses through the stages of the adder tree 306. This reduction in bits may correspond to the O(log 2(n/2)) depth of the adder tree 306, where n is the number of bits in the input value.

FIG. 3G illustrates a series of reduction stages 334, 336, 338, 340, and an output stage 342 associated with the hardware-based integer divide-by-prime operation. As used herein, the term “reduction stage” may refer to a step in the division process where the number of bits is reduced through parallel addition operations. Each reduction stage may correspond to a level in the adder tree 306.

The first reduction stage 334 may receive the initial bitfield 330 and perform the first set of parallel additions. In some implementations, the first reduction stage 334 may utilize look-ahead carry logic to predict carry-out bits, potentially improving the speed of the addition operations. As used herein, the term “look-ahead carry logic” may refer to a technique used in digital circuit design to speed up addition by calculating carry bits in advance.

The second reduction stage 336 and third reduction stage 338 may continue the parallel addition process, further reducing the number of bits. In some implementations, these stages may employ carry-save adders to minimize carry propagation delays. As used herein, the term “carry-save adder” may refer to a type of digital adder used in computer architecture that outputs its carry bits separately from its sum bits, potentially reducing the overall delay of the addition operation.

The fourth reduction stage 340 may represent the final stage of parallel additions before the output stage. In some implementations, the fourth reduction stage 340 may use parallel prefix adders to perform the additions with logarithmic time complexity. As used herein, the term “parallel prefix adder” may refer to a class of adders that compute the sum and carry bits for each bit position in parallel, potentially reducing the overall latency of the addition operation.

The output stage 342 may produce the final quotient of the division operation. In some implementations, the output stage 342 may include a truncation operation based on the pre-calculated offset. As used herein, the term “truncation” may refer to the process of removing a specified number of least significant bits from a binary number to adjust its precision or scale.

In some implementations, the reduction stages may be implemented using a systolic array architecture. As used herein, the term “systolic array” may refer to a network of processors that rhythmically compute and pass data through the system. This approach may offer improved scalability and efficiency for larger input sizes or more complex divisors. In some implementations, the reduction stages may be implemented using a Wallace tree structure. a “Wallace tree” may refer to an efficient hardware implementation of a digital circuit that multiplies two integers. This approach may be particularly effective for division operations involving large prime numbers or their multiples. In some implementations, the reduction stages may utilize a Booth encoding scheme to reduce the number of partial products. As used herein, the term “Booth encoding” may refer to a method for multiplying binary numbers in two's complement notation. This approach may offer improved performance for division operations involving certain types of divisors.

Some implementations may implement the reduction stages using a residue number system (RNS). As used herein, the term “residue number system” may refer to a number system where a large integer is represented by a set of smaller integers, called residues. This approach may offer advantages in terms of parallel processing and error detection for certain types of division operations. In some implementations, the reduction stages may be implemented using a quantum circuit. As used herein, the term “quantum circuit” may refer to a model for quantum computation in which a computation is a sequence of quantum gates. This approach may offer significant speed improvements for certain types of division operations.

In some implementations, the divider 300 may be configured to perform division operations using a composition of factors. This approach may allow for efficient division by a wide range of divisors, including those that are not prime numbers or simple multiples of prime numbers. For example, the divider 300 may decompose a complex divisor into a combination of simpler factors that can be processed more efficiently. The divider 300 may include a factor composition module that analyzes the divisor and determines an optimal combination of factors to use for the division operation. In some cases, this may involve using multiple prime factors. For instance, a division by 35 may be decomposed into a division by 5 followed by a division by 7, or vice versa. This decomposition may allow the divider 300 to leverage optimized division paths for smaller prime factors, potentially improving overall performance. In some implementations, the divider 300 may maintain a lookup table or other data structure that stores pre-computed factor compositions for common divisors. This may allow for rapid decomposition of divisors into their optimal factor combinations, reducing the computational overhead associated with factor analysis.

The divider 300 may be particularly efficient at handling divisors that are powers of two or clean multiples of small prime numbers. For example, divisions by 2, 4, 8, 16, and so on may be implemented using simple bit shift operations. Similarly, divisions by 3, 5, 7, and their multiples (e.g., 6, 9, 10, 12, 14, 15) may be optimized using dedicated hardware paths or pre-computed factor compositions. In some cases, the divider 300 may be configured to accelerate division operations for a subset of possible divisors, focusing on those that are most commonly used or that provide the greatest performance benefits. For example, the divider 300 may include optimized paths for divisions by 3 and 5, as these factors can be used to compose a large number of other divisors. In some implementations, the divider 300 may include detection logic to identify when an input value is divisible by certain factors, allowing it to route the operation to the most efficient processing path. This detection may be based on analyzing the binary representation of the input value or using pre-computed lookup tables. Various aspects of the approaches described above may provide performance improvements for many common division operations while maintaining a reasonable hardware footprint.

The divider 300 may be implemented in various hardware configurations, including but not limited to CXL expander devices, general-purpose divider blocks, and cryptographic modules. In a CXL expander implementation, the divider 300 may be used to efficiently calculate physical addresses for memory interleaving, supporting modes such as 3-way, 6-way, and 12-way interleaving. In some implementations, the divider 300 may be integrated into existing iterative divider designs as an optimization. For example, the divider 300 may include logic to detect when an input value is divisible by common factors such as 3 or 5, and route these operations to an accelerated path using the parallel adder tree structure. This hybrid approach may provide performance improvements for a wide range of division operations while maintaining compatibility with existing divider interfaces.

The divider 300 may also find applications in cryptographic operations, where efficient division by prime numbers is often desired. The ability to perform rapid divisions by complex primes may accelerate various cryptographic algorithms and protocols. In some implementations, the divider 300 may enable more flexible scheduling schemes in computing systems. For example, it may allow for efficient implementation of round-robin or time-division scheduling algorithms that use non-power-of-two increments, such as dividing resources among 12 cores.

The divider 300 represents an advancement in integer division techniques, recasting the traditional long division process into a pipeline-able tree of parallel adders. This approach leverages the efficiency and simplicity of adder circuits in hardware implementations, potentially offering improved performance and reduced power consumption compared to conventional division logic.

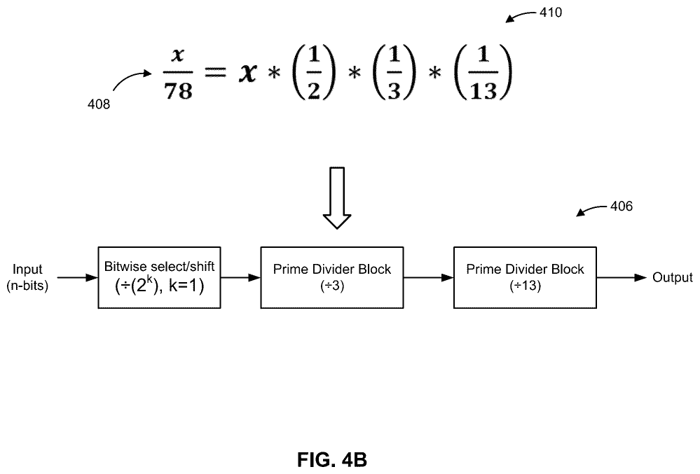

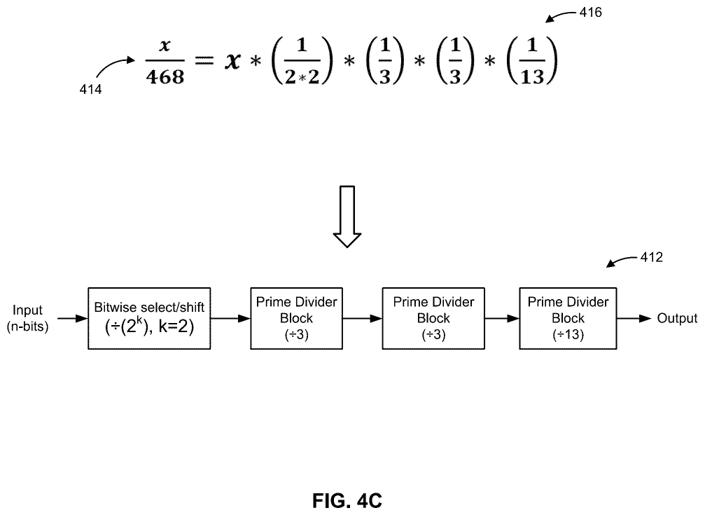

FIGS. 4A-4C are diagrams illustrating examples of dividers for performing hardware-based integer divide-by-prime operations.

FIGS. 4A-4C are diagrams illustrating examples of divider structures for performing hardware-based integer divide-by-prime operations. FIG. 4A illustrates a divider 400 configured to perform a division operation 402 using a prime number or a multiple of a prime number as a divisor. In this case, because the division operation 402 can be rewritten as a factorization 404, x*(½)*( 1/19), it may be calculated using the input shifter with k=1 and one prime divider block 406.

FIG. 4B depicts a divider 406 configured to perform a division operation 408. In this example, the division operation 408 can be rewritten as a factorization 410, x*(½)*(⅓)*( 1/13). The divider 406 may be implemented using an input shifter with k=1 and two prime divider blocks in series. The first prime divider block in the divider 406 may be configured to perform division by 3, while the second prime divider block may be configured to perform division by 13. This arrangement leverages the principle of factor composition, as discussed in relation to the divider 300 in FIG. 3A. By breaking down the complex divisor into its prime factors, the divider 406 can utilize optimized hardware paths for each prime division, potentially improving overall performance and efficiency.

FIG. 4C illustrates a divider 412 designed to perform a division operation 414 using a larger composite number as a divisor. The division operation 414 can be rewritten as a factorization 416, x*(½*2)*(⅓)*(⅓)*( 1/13). In this case, the divider 412 may be implemented using an input shifter with k=2 (for the division by four) and three prime divider blocks connected in series. This configuration demonstrates the scalability of the divider architecture, allowing it to handle increasingly complex divisors by adding more prime divider blocks as needed.

The divider structures shown in FIGS. 4A-4C may incorporate various features and optimizations discussed in relation to the divider 300 in FIG. 3A. For example, each prime divider block may utilize a tree of parallel adders similar to the adder tree 306. These adder trees may be designed with a depth of O(log 2(n/2)), where n is the number of bits in the input value, to optimize performance. Additionally, the prime divider blocks may employ techniques such as look-ahead carry logic, carry-save adders, or parallel prefix adders to further enhance the speed of the division operations.

In some implementations, the dividers 400, 406, and 412 may include detection logic to identify when an input value is divisible by certain factors. This detection logic may analyze the binary representation of the input value or use pre-computed lookup tables to determine the most efficient processing path. For instance, if the detection logic in the divider 412 determines that the input value is divisible by 3 and 5 but not by 19, it may route the operation through only the relevant prime divider blocks, potentially reducing the overall computation time.

The divider structures illustrated in FIGS. 4A-4C may be particularly useful in applications such as CXL memory interleaving, where efficient calculation of physical addresses is desired. For example, the divider 400 in FIG. 4A may be used to support 3-way interleaving (when dividing by 3), while the divider 406 in FIG. 4B could support 6-way interleaving (when dividing by 6). The divider 412 in FIG. 4C, with its ability to handle more complex divisors, may be used to support various interleave modes, including 12-way interleaving (when dividing by 12).

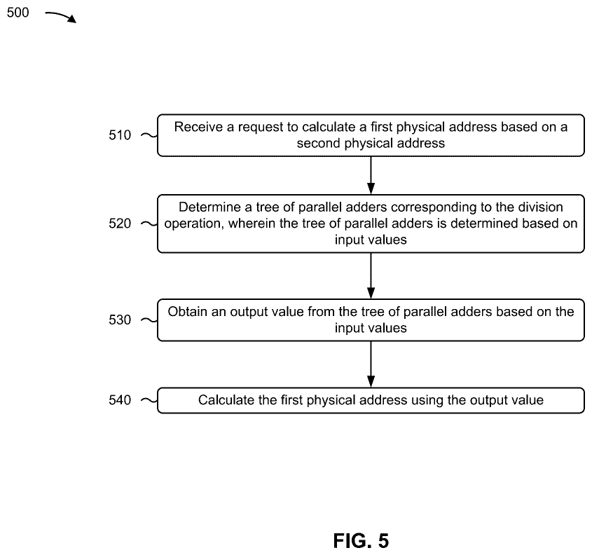

FIG. 5 is a flowchart of an example process 500 associated with determining physical addresses of memory devices using division by prime numbers. In some implementations, one or more process blocks of FIG. 5 may be performed by a memory system (e.g., the memory system 100 shown in FIG. 1). In some implementations, one or more process blocks of FIG. 5 may be performed by another device or a group of devices separate from or including the memory system, such as a CXL memory controller (e.g., the CXL memory controller 106 shown in FIG. 1) and/or a memory controller (e.g., the memory controller 108 shown in FIG. 1). Additionally, or alternatively, one or more process blocks of FIG. 5 may be performed by one or more components of device 200, such as processor 220, memory 230, storage component 240, input component 250, output component 260, and/or communication interface 270.

As shown in FIG. 5, process 500 may include receiving a request to calculate a first physical address of an external device based on a second physical address of the host device (block 510). The first physical address of the external device may be calculated based on a division operation that divides the second physical address by a divisor that includes a prime number. As further shown in FIG. 5, process 500 may include determining a tree of parallel adders corresponding to the division operation (block 520). The tree of parallel adders may be determined based on input values that include a number of bits of the second physical address and the divisor.

As further shown in FIG. 5, process 500 may include obtaining an output value from the tree of parallel adders based on the input values (block 530). The number of bits of the second physical address may be a first number of bits, and obtaining the output value may include performing a shift operation to shift the second physical address by a second number of bits that is based on the divisor and determining a rounding factor based on the number of bits. Obtaining the output value may include obtaining the output value based on the rounding factor. In some implementations, obtaining the output value may include obtaining the output value based on the tree of parallel adders implementing a function that is based on a shifting value, a constant, a rounding factor, and an offset. The shifting value, the constant, the rounding factor, and/or the offset may be based determined based on at least one of the number of bits or the divisor.

As further shown in FIG. 5, process 500 may include calculating the first physical address using the output value (block 540). In some implementations, the process 500 may further include determining an offset based on the number of bits and the prime number. Calculating the first physical address may include truncating the output value based on the offset. The offset may include a particular number of bits. In some implementations, the process 500 may include determining a number of data reduction stages of the tree of parallel adders based on the offset, pre-calculating output values for a first data reduction stage of the reduction stages and determining a constant based on the offset. Obtaining the output value may include obtaining the output value based on the constant and determining a vector based on the offset and the divisor. Obtaining the output value may include obtaining the output value based on the vector. In some implementations, the process 500 may include determining one or more prime numbers that are included in the prime numbers and determining a number of adders, of the tree of parallel adders, based on the one or more prime numbers.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

Some embodiments are described as numbered examples (Example 1, 2, 3, etc.). These are provided as examples only and do not limit the technology disclosed herein.
Example 1 includes a method performed by a processing unit associated with a host device, the method comprising: receiving a request to calculate a first physical address of an external device based on a second physical address of the host device, wherein the first physical address of the external device is to be calculated based on a division operation that divides the second physical address by a divisor that includes a prime number; determining a tree of parallel adders corresponding to the division operation, wherein the tree of parallel adders is determined based on input values that include a number of bits of the second physical address and the divisor; obtaining an output value from the tree of parallel adders based on the input values; and calculating the first physical address using the output value.
Example 2 includes the method of Example 1, wherein the number of bits of the second physical address is a first number of bits, and wherein obtaining the output value comprises: performing a shift operation to shift the second physical address by a second number of bits that is based on the divisor.
Example 3 includes the method of either of Examples 1 or 2, further comprising: determining an offset based on the number of bits and the prime number; and wherein calculating the first physical address comprises: truncating the output value based on the offset, wherein the offset includes a particular number of bits.
Example 4 includes the method of Example 3, further comprising determining a number of data reduction stages of the tree of parallel adders based on the offset.
Example 5 includes the method of Example 4, further comprising pre-calculating output values for a first data reduction stage of the reduction stages.
Example 6 includes the method of Example 5, further comprising determining a constant based on the offset, wherein obtaining the output value comprises obtaining the output value based on the constant.
Example 7 includes the method of Example 5, further comprising determining a vector based on the offset and the divisor, wherein obtaining the output value comprises obtaining the output value based on the vector.
Example 8 includes the method of any of Examples 1-7, further comprising determining one or more prime numbers that are included in the prime numbers; and determining a number of adders, of the tree of parallel adders, based on the one or more prime numbers.
Example 9 includes the method of any of Examples 1-8, further comprising determining a rounding factor based on the number of bits, wherein obtaining the output value comprises obtaining the output value based on the rounding factor.
Example 10 includes the method of any of Examples 1-9, wherein obtaining the output value comprises obtaining the output value based on the tree of parallel adders implementing a function that is based on a shifting value, a constant, a rounding factor, and an offset; wherein the shifting value, the constant, the rounding factor, and the offset are based determined based on at least one of the number of bits or the divisor.
Example 11 includes a system comprising a processing unit, associated with a host device, adapted to receive a request to calculate a first physical address of an external device based on a second physical address of the host device, wherein the first physical address of the external device is to be calculated based on a division operation that divides the second physical address by a divisor; determine a tree of parallel adders corresponding to the division operation, wherein the tree of parallel adders is determined based on input values that include a number of bits of the second physical address and a divisor; obtain an output value from the tree of parallel adders based on the input values; and calculate the first physical address using the output value.
Example 12 includes the system of Example 11, wherein, to obtain the output value, the processing unit is adapted to perform a shift operation to shift the second physical address by a number of bits that is based on a power of two associated with the divisor.
Example 13 includes the system of either of Examples 11 or 12, wherein the processing unit is adapted to determine an offset based on the number of bits and a logarithm of the divisor at base two; and wherein, to calculate the first physical address, the processing unit is adapted to truncate the output value based on the offset, wherein the offset includes a particular number of bits.
Example 14 includes the system of Example 13, wherein the processing unit is adapted to determine a number of data reduction stages of the tree of parallel adders based on a logarithm of a value at base two, wherein the value is based on the offset.
Example 15 includes the system of Example 14, wherein the processing unit is adapted to pre-calculate output values for a first data reduction stage of the reduction stages.
Example 16 includes the system of any of Examples 13-15, wherein the processing unit is adapted to determine a constant based on the offset and the divisor; and wherein, to obtain the output value, the processing unit is adapted to obtain the output value based on the constant. Example 17 includes the system of any of Examples 13-16, wherein the first physical address is a memory interleave address, and wherein the division operation is an iterative division.
Example 18 includes the system of any of Examples 13-17, wherein, to obtain the output value, the processing unit is adapted to obtain the output value based on the tree of parallel adders implementing a function that is based on a shifting value, a constant, a rounding factor, and an offset; and wherein the shifting value, the constant, the rounding factor, and the offset are determined based on at least one of the number of bits or the divisor.
Example 19 includes a computer program product comprising: one or more computer readable storage media, and program instructions collectively stored on the one or more computer readable storage media, the program instructions comprising: program instructions to receive a request to calculate a first physical address of an external device based on a second physical address of the host device, wherein the first physical address of the external device is to be calculated based on a division operation that divides the second physical address by a divisor; program instructions to determine a tree of parallel adders corresponding to the division operation, wherein the tree of parallel adders is determined based on input values that include a number of bits of the second physical address and a divisor; program instructions to obtain an output value from the tree of parallel adders based on the input values; and program instructions to calculate the first physical address using the output value.
Example 20 includes the computer program product of Example 19, wherein the program instructions to obtain the output value comprise program instructions to obtain the output value based on the tree of parallel adders implementing a function that is based on a shifting value, a constant, a rounding factor, and an offset; and wherein the shifting value, the constant, the rounding factor, and the offset are based determined based on at least one of the number of bits or the divisor.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems or methods described herein may be implemented in different forms of hardware, firmware, or a combination of hardware and software. The actual control hardware or software code used to implement these systems or methods is not limiting of the implementations. Thus, the operation and behavior of the systems or methods are described herein without reference to specific software code-it being understood that software and hardware can be used to implement the systems or methods based at least in part on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims or disclosed in the specification, these combinations are not intended to limit the disclosure of various implementations. In fact, many of these features may be combined in ways not specifically recited in the claims or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a−b, a−c, b−c, and a−b−c, as well as any combination with multiple of the same item.

No element, act, or instruction used herein is to be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “or,” unless explicitly stated otherwise (e.g., if used in combination with “either” or “only one of”).

What is claimed is:

1. A method comprising:
receiving a request to calculate a first physical address based on a second physical address,
wherein the first physical address is to be calculated based on a division operation that divides the second physical address by a divisor that includes a prime number;
determining a tree of parallel adders corresponding to the division operation,
wherein the tree of parallel adders is determined based on input values that include a number of bits of the second physical address and the divisor;
obtaining an output value from the tree of parallel adders based on the input values; and
calculating the first physical address using the output value.

2. The method of claim 1, wherein the number of bits of the second physical address is a first number of bits, and
wherein obtaining the output value from the tree of parallel adders comprises:
performing a shift operation to shift the second physical address by a second number of bits that is based on the divisor.

3. The method of claim 1, comprising:
determining an offset based on the number of bits and the prime number; and wherein calculating the first physical address comprises:
truncating the output value based on the offset,
wherein the offset includes a particular number of bits.

4. The method of claim 3, comprising:
determining a number of data reduction stages of the tree of parallel adders based on the offset.

5. The method of claim 4, comprising:
pre-calculating output values for a first data reduction stage of the data reduction stages.

6. The method of claim 5, comprising:
determining a constant based on the offset; and
wherein obtaining the output value comprises:
obtaining the output value based on the constant.

7. The method of claim 5, comprising:
determining a vector based on the offset and the divisor; and
wherein obtaining the output value comprises:
obtaining the output value based on the vector.

8. The method of claim 1, comprising:
determining one or more prime numbers that include in the prime number; and
determining a number of adders, of the tree of parallel adders, based on the one or more prime numbers.

9. The method of claim 1, comprising:
determining a rounding factor based on the number of bits; and
wherein obtaining the output value comprises:
obtaining the output value based on the rounding factor.

10. The method of claim 1, wherein obtaining the output value from the tree of parallel adders comprises:
obtaining the output value based on the tree of parallel adders implementing a function that is based on a shifting value, a constant, a rounding factor, and an offset,
wherein the shifting value, the constant, the rounding factor, and the offset are based on at least one of the number of bits or the divisor.

11. A system comprising:
a first device;
a second device; and
a processing unit to:
determine a tree of parallel adders corresponding to a division operation to calculate a first physical address of the first device based on a second physical address of the second device,
wherein the first physical address of the first device is to be calculated based on a division operation that divides the second physical address by a divisor, and
wherein the tree of parallel adders is determined based on input values that include a number of bits of the second physical address and a divisor; and
calculate the first physical address using an output value from the tree of parallel adders.

12. The system of claim 11, wherein, to obtain the output value, the processing unit is to:
perform a shift operation to shift the second physical address by a number of bits that is based on a power of two associated with the divisor.

13. The system of claim 11, wherein the processing unit is to:
determine an offset based on the number of bits and a logarithm of the divisor at base two; and
wherein, to calculate the first physical address, the processing unit is to:
truncate the output value based on the offset,
wherein the offset includes a particular number of bits.

14. The system of claim 13, wherein the processing unit is to:
determine a number of data reduction stages of the tree of parallel adders based on a logarithm of a value at base two,
wherein the value is based on the offset.

15. The system of claim 13, wherein the processing unit is to:
pre-calculate output values for a first data reduction stage of the reduction stages.

16. The system of claim 13, wherein the processing unit is to:
determine a constant based on the offset and the divisor; and
wherein, to obtain the output value, the processing unit is to:
obtain the output value based on the constant.

17. The system of claim 13, wherein the first physical address is a memory interleave address, and
wherein the division operation is an iterative division.

18. The system of claim 13, wherein, to obtain the output value, the processing unit is to:
obtain the output value based on the tree of parallel adders implementing a function that is based on a shifting value, a constant, a rounding factor, and an offset,
wherein the shifting value, the constant, the rounding factor, and the offset are based on at least one of the number of bits or the divisor.

19. A computer program product comprising:
one or more computer readable storage media, and program instructions collectively stored on the one or more computer readable storage media, the program instructions comprising:
program instructions to receive a request to calculate a first physical address of a first device based on a second physical address of the second device,
wherein the first physical address of the first device is to be calculated based on a division operation that divides the second physical address by a divisor;
program instructions to determine a tree of parallel adders corresponding to the division operation,
wherein the tree of parallel adders is determined based on input values that include a number of bits of the second physical address and a divisor;
program instructions to obtain an output value from the tree of parallel adders based on the input values; and
program instructions to calculate the first physical address using the output value.

20. The computer program product of claim 19, wherein the program instructions to obtain the output value comprise:
program instructions to obtain the output value based on the tree of parallel adders implementing a function that is based on a shifting value, a constant, a rounding factor, and an offset,
wherein the shifting value, the constant, the rounding factor, and the offset are determined based on at least one of the number of bits or the divisor.
